(19) United States
(12) Patent Application Publication
(10) Pub. No.: US 2004/0037415 A1
(43) Pub. Date: Feb. 26, 2004

(54) Computer program for allocating transactions to operators

(75) Inventor: Hideki Yamanaka, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/607,999

(22) Filed: Jun. 30, 2003

(30) Foreign Application Priority Data
Jul. 19, 2002 (JP) 2002-211599

(51) Int. Cl. H04M 3/00; H04M 5/00

(52) U.S. Cl. 379/265.01; 379/265.05

(57) ABSTRACT

Information such as status of each operator that is information about whether the operator is engaged in processing a transaction or he is standby, how long it will take the operator to complete the transaction he is processing at this time, and when the operator started processing the transaction is stored. If a plurality of the operators are standby when a transaction is received, one operator is selected from among the standby operators as an operator to process the transaction. If no operator is standby, it is estimated when each operator is going to be standby and one operator is selected, from among the operators who are going to be standby in not more than a predetermined time, as the operator to process the transaction.

### BACKGROUND OF THE INVENTION

1) Field of the Invention

The present invention relates to a computer program for selecting an appropriate operator, from among a plurality of operators, for performing a transaction requested by a customer to thereby make even the load on the operators.

2) Description of the Related Art

Contact centers or call centers for handling customer supporting operation are known in the art. These centers receive transactions from the customers via telephone, chat, or e-mail. These transactions are then processed by the operators associated with theses centers. Since there are generally many operators and some of are the operators may be already busy processing some other transactions, it is required to select an operator to process the transaction and allocate the transactions to that operator (hereinafter, “carry out a transaction allocation processing”). The transaction allocation processing according to the conventional art will be briefly explained below.

The contact center first receives transactions from customers, and lists up candidate operators to whom the transactions are allocated. For example, when the contact center receives an English transaction, the contact center lists up operators who can communicate in English on the phone. Next, the contact center decides whether the operators listed up are available to process the transaction. In other words, the contact center decides whether the operators listed up are standby or in work based on whether their telephone line is free or in use.

If some operators are standby, then the contact center decides for how long these operators were standby based on how long their telephone line was free. Then the contact center selects an operator who is standby for longest duration and allocates the transaction to that operator. The selected operator then processes the transaction.

On the other hand, if none of the operator is standby and the transaction is telephone, the contact center sequentially selects e-mail processing operators to interrupt from the head to the end or from the end to the head of the list. Thus, if the operators are listed up based on their IDs, then the contact center sequentially selects operators whose ID numbers are the smallest or the largest.

However, according to the above conventional art, there has been a problem that the loads of the operators who process the transactions are not made even. This problem will be explained with reference to FIG. 14. FIG. 14 shows a state of processing transactions according to the conventional art. The graph in FIG. 14 shows for how long each operator was busy. For example, operators with ID numbers 35 to 70 are in a group of skilled operators who are engaged in receiving e-mails in Japanese and receiving telephone calls in Japanese.

In this particular group, when the operators are receiving the telephone calls, the operators with lower IDs are busy for a longer time than the operators with higher IDs. On the other hand, when the operators are receiving the e-mails, the operators with higher IDs are busy for a longer time than the operators with lower IDs. This is for the following reason. In the transaction allocation processing, when none of the operators in this group are standby, the telephone transactions are sequentially allocated to the operators starting from the operators who are at the head of the list, and the e-mail transactions currently processed by these operators are interrupted.

In other words, according to the conventional art, when all the operators within a predetermined group are currently processing transactions, the contact center sequentially selects e-mail processing operators starting from the operators who are at the head of the group list, and allocates the telephone transactions to these selected operators. Therefore, when the operators have smaller operator ID numbers, the operators' operating times relating to the telephone transactions become longer. On the other hand, when the operators have larger operator ID numbers, the operators' operating times relating to the e-mail transactions become longer. As a result, the total processing times of the transactions of telephone call receptions and e-mail receptions are not averaged, and it has not been able to make even the load of each operator.

### SUMMARY OF THE INVENTION

It is an object of the present invention to solve at least the problems in the conventional technology.

According to the apparatus and method of the present invention, information such as status of each operator that is information about whether the operator is engaged in processing a transaction or he is standby, how long it will take the operator to complete the transaction he is processing at this time, and when the operator started processing the transaction is stored. If many operators are standby when a transaction is received, one operator is selected, from among the standby operators, as an operator to process the transaction. If no operator is standby, it is estimated when each operator is going to be standby and one operator is selected, from among the operators who are going to be standby in not more than a predetermined time, as the operator to process the transaction.

The computer program according to the present invention realizes the method according to the present invention on a computer.

The other objects, features and advantages of the present invention are specifically set forth in or will become apparent from the following detailed descriptions of the invention when read in conjunction with the accompanying drawings.

### BRIEF DESCRIPTION OF THE DRAWINGS

FIG. 1 shows a structure of a system that includes a transaction allocation apparatus according to a first embodiment of the present invention;

FIG. 2 is a block diagram that shows a structure of the transaction allocation apparatus according to the first embodiment;

FIGS. 3A and 3B explain about priority queues and a transaction that are managed by a priority queue managing section;

FIGS. 4A and 4B explain about an operator queue and a transaction that are managed by an operator queue managing section;

FIG. 5 shows an example of a structure of information stored in the operator database;

FIG. 6 explains about information managed by a processing state managing section;

FIG. 7 is a flowchart that shows an outline process of a transaction allocation processing;

FIG. 8 is a flowchart that shows a detailed process of the transaction allocation processing;

FIG. 9 is a flowchart that shows a process of an estimated standby state list preparation processing;

FIG. 10 explains about a relationship between an estimated standby time and equalization of operator load;

FIG. 11 shows a state of processing transactions according to the present invention;

FIG. 12 shows a structure of a computer system according to a second embodiment;

FIG. 13 is a block diagram that shows a structure of a main body of the computer system shown in FIG. 12; and

FIG. 14 shows a processing state of transactions according to the conventional art.

### DETAILED DESCRIPTION

Exemplary embodiments of a transaction allocation program according to the present invention will be explained in detail below with reference to the accompanying drawings. In a first embodiment, a transaction allocation apparatus and a transaction allocation method for achieving functions similar to those of the transaction allocation program according to the present invention will be explained. In a second embodiment, a computer system for executing the transaction allocation program according to the present invention will be explained. Last, various modifications of the embodiments will be explained.

The first embodiment relates to a transaction allocation apparatus that achieves functions similar to those of the transaction allocation program according to the present invention. An outline of a system that includes the transaction allocation apparatus according to the first embodiment and main characteristics thereof will be explained first. Next, a structure of this transaction allocation apparatus will be explained. Finally, a process of the transaction allocation processing will be explained.

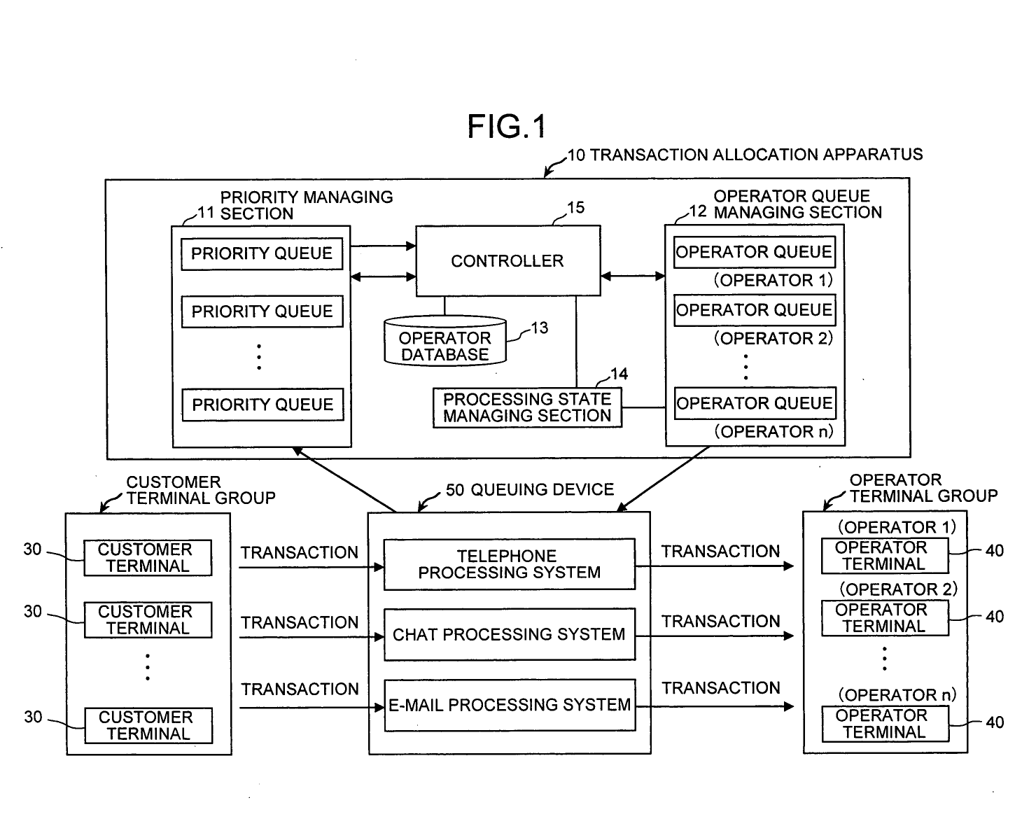

First, the outline of the system that includes the transaction allocation apparatus according to the first embodiment will be explained. FIG. 1 shows a structure of the system that includes the transaction allocation apparatus according to the first embodiment. This system is built up in a contact center that receives transactions from customers via multi-channels such as telephone (i.e., a real-time system), chat (i.e., an interactive system), and e-mail (i.e., a non-interactive system), and makes a plurality of operators process the received transactions.

In other words, as shown in FIG. 1, the system receives transactions from customer terminals 30 (a group of customer terminals shown in the drawing) of customers via any one or combinations of telephone, chat, and e-mail, and allocates the received transactions to operator terminals 40 (a group of operator terminals shown in the drawing) of operators. In the operator terminal 40 of each operator, an integrated application of the three systems of telephone, chat, and e-mail operates, and processes the transaction of each system.

In this system, a transaction allocation apparatus 10 selects an operator to process the transactions received from the customers from among a plurality of operators, and allocates the transactions to the operator terminals 40 of the operator selected. The outline of the processing of this system will be explained next.

The transaction allocation apparatus 10 includes a priority managing section 11 that stores a plurality of priority queues each reflecting high and low priorities. Each priority queue has a queue for each of a telephone system class, a chat system class, and an e-mail system class. A queuing device 50 connected to each channel as an entrance to the contact center receives transactions from the customer terminals 30 via the three systems of telephone, chat, and e-mail, and sets these transactions in predetermined priority queues in the priority queue managing section 11 of the transaction allocation apparatus 10.

More specifically, the queuing device 50 determines a class to which the transaction received from the customer is to be set in a queue, based on the system via which this transaction is received. At the same time, the queuing device 50 determines a priority queue to which the transaction is to be set, based on a type of a customer ID (such as a Very Important Person (VIP) customer or a general customer), a type of a reception channel (such as a channel corresponding to English or Japanese), and information (such as brief contents of the transaction) obtained by the Interactive Voice Response (IVR) apparatus. The queuing device 50 sets the transaction in a predetermined class of a predetermined priority queue according to these determinations. In other words, when the transaction has a high importance level, the queuing device 50 sets this transaction in a priority queue of a high priority. When the transaction has a low importance level, the queuing device 50 sets this transaction in a priority queue of a low priority.

Further, in this queuing, the queuing device 50 sets a type of the operation of the transaction (such as Japanese or English), a skill level (i.e., a required skilled level) strictly required in the transaction processing, a waiting time (i.e., a permissible waiting time) permitted before the transaction processing is started, based on the system of the transaction, the type of the customer ID, the type of the reception channel, and the information obtained by the IVR apparatus. The queuing device 50 adds the transaction reception time, the required skill level, and the permissible waiting time to the transaction, and sets this transaction in a queue.

The required skill level is set by taking into account whether a communication in English is necessary or whether a considerable technical level is required, for example. The permissible waiting time is set longer in the order of the telephone system, the chat system, and the e-mail system. Further, there is a variation such that a shorter permissible waiting time is set for a VIP customer.

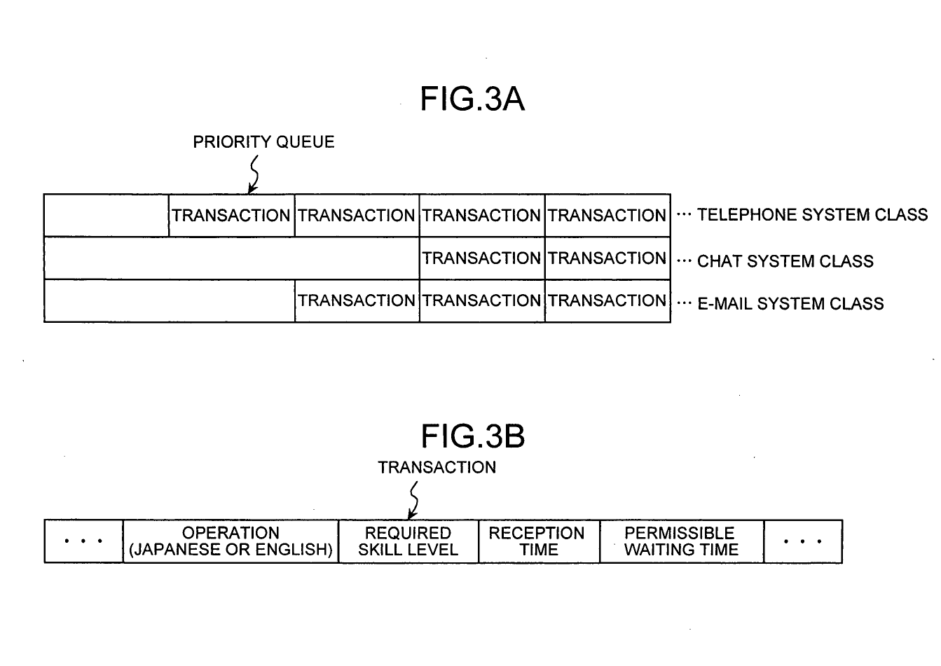

The transactions received from the customers based on the processing of the queuing device 50 are sequentially queued in predetermined classes of predetermined priority queues in the priority queue managing section 11 of the transaction allocation apparatus 10, in the state that each of these transactions is added with the type of the operation of the transaction (such as Japanese or English), the reception time, the required skilled level, and the permissible waiting time (refer to FIGS. 3A and 3B).

On the other hand, in the transaction allocation apparatus 10, as shown in FIG. 1, an operator queue managing section 12 has an operator queue for each operator. Each operator queue has a queue for each of the three classes of the telephone system class, the chat system class, and the e-mail system class. A controller 15 of the transaction allocation apparatus 10 sequentially selects operators who process the transactions that are queued in the priority queue managing section 11, and sequentially allocates the transactions to the operator queues of the selected operators, as the transaction allocation processing.

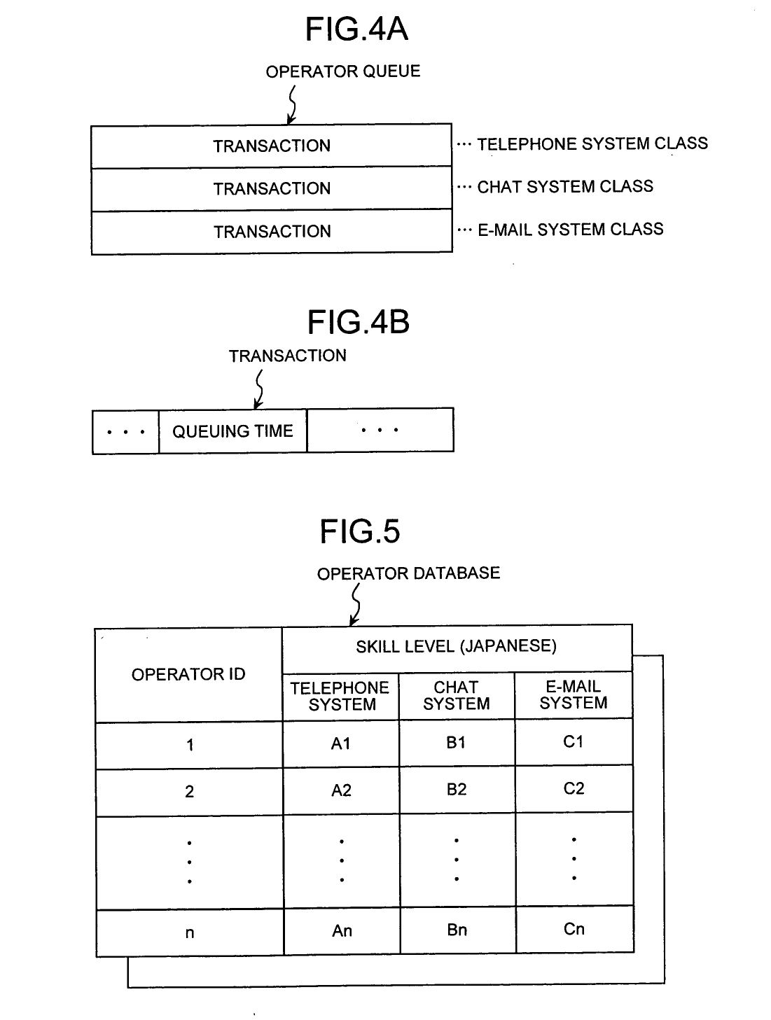

In other words, the controller 15 controls to sequentially shift the transactions queued in the priority queue managing section 11 of the transaction allocation apparatus 10, to predetermined classes of predetermined operator queues respectively in the operator queue managing section 12 (refer to FIGS. 4A and 4B). Each operator sequentially processes the transactions queued in the own operator queue via the operator terminal 40. The transactions queued in the operator queue managing section 12 are deleted after the operators finish processing these transactions.

In each operator terminal 40 of each operator, the integrated application of the three systems including telephone, chat, and e-mail operates, and the operator processes the transactions of each system. On the other hand, the transaction allocation apparatus 10 interrupts transactions to the operators by taking into account the characteristics of each system. In other words, when the operator is processing a transaction in the telephone system, the operator can communicate with only one customer at one time. Therefore, the transaction allocation apparatus 10 does not interrupt this operator with an additional transaction. However, when the operator is processing a transaction in the chat or e-mail system, the transaction allocation apparatus 10 interrupts this operator with a telephone transaction, a chat having a higher priority, or an e-mail transaction.

Main characteristics of the system shown in FIG. 1 will be explained next. As explained above, according to this system, the transaction allocation apparatus 10 allocates the transactions received from the customers to the operators to make these operators process the allocated transactions. In this system, the transaction allocation apparatus 10 has main characteristics in its processing. Specifically, the transaction allocation apparatus 10 allocates transactions in such a way as to average the total processing time for each channel taken by the same group operator to process transactions, thereby to make even the load of the same group operator. The main characteristics will be briefly explained based on the outline of the transaction allocation processing.

As shown in FIG. 1, the transaction allocation apparatus 10 has an operator database (DB) 13 that manages the skill level of each operator to process a transaction, and a processing state managing section 14 that manages the processing state of transactions processed by the operators for each system of telephone, chat, and e-mail (i.e., an estimated processing time taken to process the transaction, and a processing starting time that shows the time when the transaction currently under processing has started). The estimated processing time shows the estimated time taken to process the transaction. For example, an average processing time calculated based on a few past records of transaction processing time, or an instantaneous processing time dynamically estimated with an estimator, is allocated as the estimated processing time.

In the transaction allocation processing, the transaction allocation apparatus 10 extracts operators whose skill levels exceed the skill level strictly required to process the transaction from the list of the candidate operators to whom the transaction is allocated, by referring to the operators' skill levels managed in the operator DB 13. Following this extraction, when some operators are standby in their processing among the transaction allocation candidate operators, the transaction allocation apparatus 10 selects the operator who processes the transaction from among these standby operators, by referring to the processing state managed by the processing state managing section 14. Then, the transaction allocation apparatus 10 sets the transaction in the operator queue of the selected operator.

On the other hand, when none of the transaction allocation candidate operators are standby, the transaction allocation apparatus 10 relaxes the skill level strictly required to process the transaction, and extracts again operators whose skill levels exceed the relaxed skill level as transaction allocation candidate operators. Following this extraction, when some operators are standby among the transaction allocation candidate operators extracted again, the transaction allocation apparatus 10 selects the operator who processes the transaction from among these standby operators, by referring to the processing state managed by the processing state managing section 14. Then, the transaction allocation apparatus 10 sets the transaction in the operator queue of this selected operator.

When none of the transaction allocation candidate operators extracted again are standby, the transaction allocation apparatus 10 subtracts the current time from the sum of the processing starting time and the estimated processing time managed by the processing state managing section 14, and calculates the estimated standby time that shows when each transaction allocation candidate operator extracted again becomes standby. Following this calculation, the transaction allocation apparatus 10 selects the operator who processes the transaction from among the operators whose estimated standby times are under a threshold time, and sets the transaction in the operator queue of the selected operator.

As explained above, when none of the transaction allocation candidate operators are standby and the transaction is telephone, according to the conventional art, e-mail processing operators are sequentially selected starting from operators who are at the head or at the end of the group list, and each transaction is allocated to each selected operator. However, according to the first embodiment, the transaction allocation apparatus 10 selects an operator from among operators whose estimated standby times are not more than a predetermined time, and allocates the transaction to this selected operator. By allocating the transaction based on the estimated standby times, the transaction allocation apparatus 10 can average the total processing time for each channel taken by the same group operator to process transactions, thereby to make even the load of such operators.

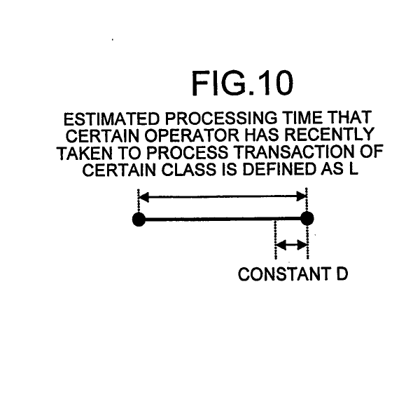

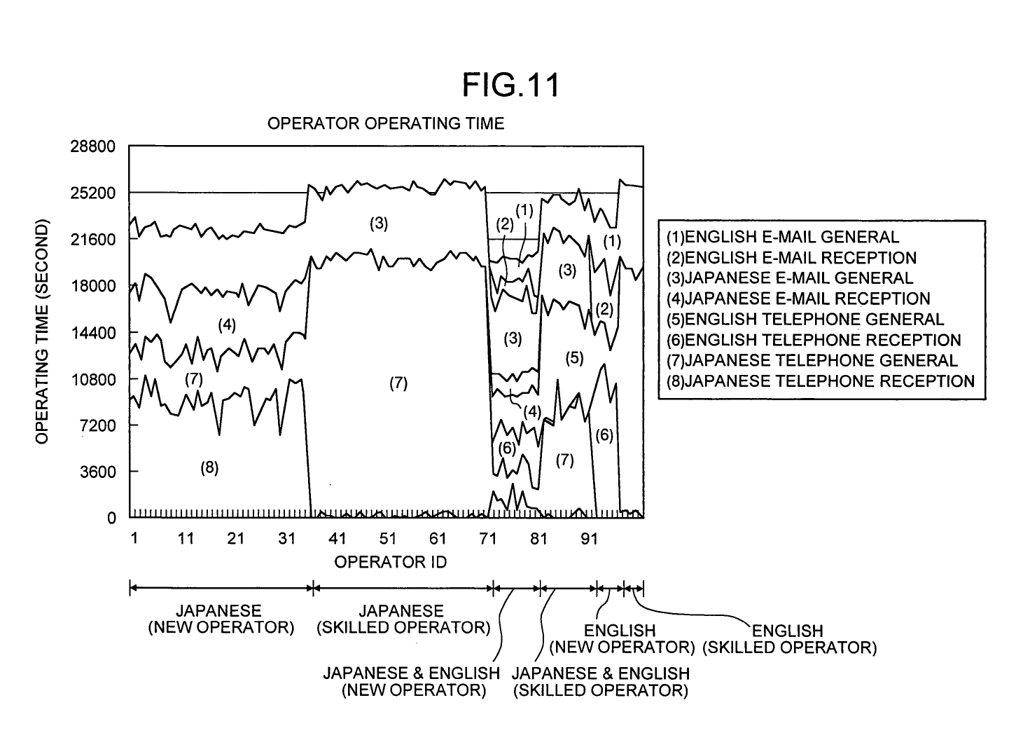

A relationship between the estimated standby time and the equalization of operator load will be explained. FIG. 10 explains about a relationship between an estimated standby time and equalization of operator load. FIG. 11 shows a state of processing transactions according to the present invention. As shown in FIG. 10, an estimated processing time that a certain operator has recently taken to process a transaction of a certain class is defined as L. Then, the probability that the estimated standby time of this operator is not more than the constant D becomes D/L when the operator is currently processing a certain transaction.

The number of times when this operator has recently processed transactions is obtained by multiplying the number of opportunities when transactions are allocated to this operator (which is the same number for all the operators in the same group) by the probability D/L. The total processing time when this operator has recently processed transactions is obtained by multiplying the estimated processing time L when the operator has recently taken to process the transaction by the number of times when this operator has recently processed transactions. In other words, “the total processing time recently taken to process transactions”=“the number of opportunities when transactions are allocated to the operator (which is the same number for all the operators in the same group)”×“the predetermined constant D”.

Therefore, when none of the allocation candidate operators (i.e., the operators in the same group) are standby, by allocating transactions to the operators whose estimated standby times are not more than the predetermined constant D, the total processing time recently taken by each operator to process transactions becomes substantially the same for all the operators in the same group, regardless of a variation in the estimated processing time taken by each operator to process a transaction, as shown in the above expression.

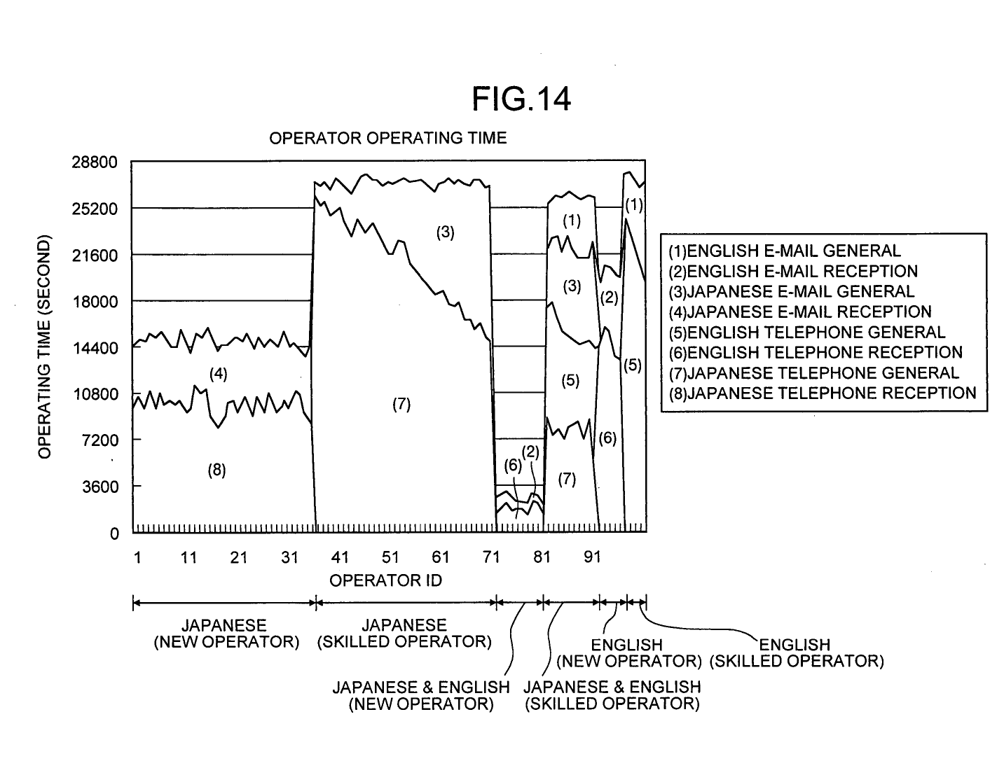

In other words, as shown in FIG. 11, according to the above transaction allocation processing, it becomes possible to average the total processing time for such channel taken by the same group operator to process transactions of each system, thereby to make even the load of each operator. Therefore, unlike the conventional art, it becomes possible to avoid such a situation that the operating times of the same group operators of smaller operator ID numbers who process the telephone transactions become longer (refer to the group of operators skilled in Japanese shown in FIG. 14, for example).

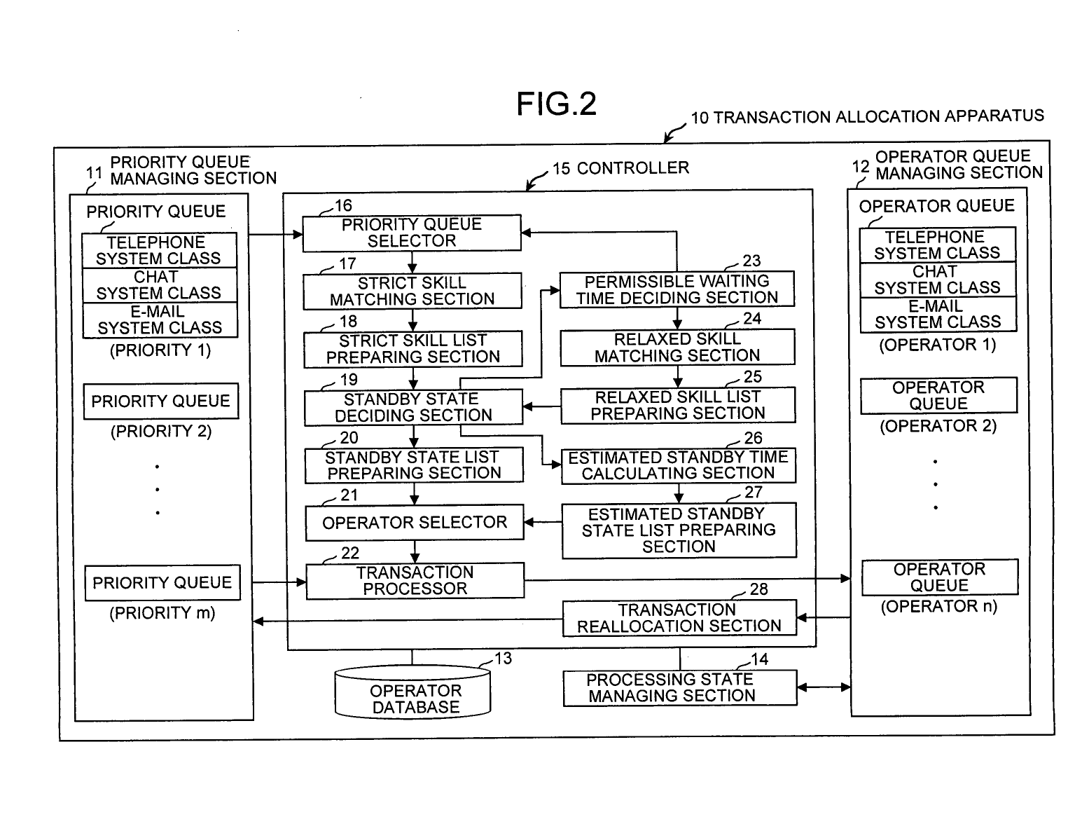

The structure of each section of the transaction allocation apparatus 10 according to the first embodiment will be explained below. FIG. 2 is a block diagram that shows the structure of the transaction allocation apparatus 10 according to the first embodiment. As shown in FIG. 2, the transaction allocation apparatus 10 includes the priority queue managing section 11, the operator queue managing section 12, the operator DB 13, the processing state managing section 14, and the controller 15.

The priority managing section 11 manages transactions queued by the queuing device 50, and has a plurality of priority queues each reflecting high and low priorities. Each priority queue has a queue for each of the three classes of the telephone system class, the chat system class, and the e-mail system class. Specifically, the priority managing section 11 manages the transactions received from customers in the state that the transactions are queued in each class of each priority queue as shown in FIG. 3A.

As explained above, the queuing device 50 sets transactions of a high importance level in a priority queue of a high priority level, based on the type of a customer ID, the type of a reception channel, and the information obtained by the Interactive Voice Response (IVR) apparatus. When the transactions have a low importance level, the queuing device 50 sets these transactions in a priority queue of a low priority. Further, as shown in FIG. 3B, the queuing device 50 sets each transaction in the queue in the state that the type of the operation of the transaction (such as Japanese or English), the skill level (i.e., the required skilled level) strictly required in the transaction processing, the transaction reception time, and the permissible waiting time permitted before the transaction processing is started, are added to the transaction.

The operator queue managing section 12 manages the transactions allocated to the operators based on the control of the controller 15, and has an operator queue for each operator. Each operator queue has a queue for each of the three classes of the telephone system class, the chat system class, and the e-mail system class. Specifically, as shown in FIG. 4A, the operator queue managing section 12 manages the transactions in the state that each transaction shifted from the priority queue managing section 11 is set in a queue to each class of each operator. In queuing the transactions shifted from the priority queue managing section 11, the operator queue managing section 12 queues the transactions in the state that a queuing time that shows the time of queuing is added to each transaction, as shown in FIG. 4B.

The operator DB 13 is the database based on which the skill level of each operator to process each transaction is managed. Specifically, as shown in FIG. 5, the skill level of each operator to process the transaction of each of the telephone system, the chat system, and the e-mail system is managed corresponding to the ID number of each operator by type of the operation such as Japanese or English.

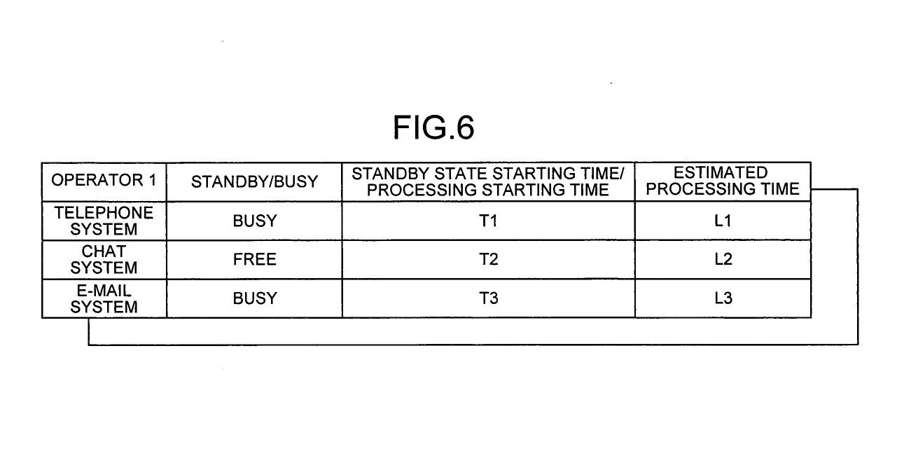

The processing state managing section 14 manages the processing state in which each operator processes each transaction, for each operator. Specifically, as shown in FIG. 6, the standby state managing section 14 manages the processing state of each operator by mutually relating information that shows whether the operator is standby (i.e., whether the operator is currently processing a transaction), a standby state starting time that shows when a standby state started when the operator is currently standby, a processing starting time that shows when the processing started when the operator is currently processing a transaction, and an estimated processing time taken to process the transaction, for each of the telephone system, the chat system, and the e-mail system, corresponding to each operator ID number.

The controller 15 has internal memories that store a control program such as an operating system (OS), a program that prescribes various kinds of processing procedures, and required data. The controller 15 executes the transaction allocation processing based on these programs and data. As a concept of functions, as shown in FIG. 2, the controller 15 has a priority queue selector 16, a strict skill matching section 17, a strict skill list preparing section 18, a standby state deciding section 19, a standby state list preparing section 20, an operator selector 21, a transaction processor 22, a permissible waiting time deciding section 23, a relaxed skill matching section 24, a relaxed skill list preparing section 25, an estimated standby time calculating section 26, an estimated standby state list preparing section 27, and a transaction reallocation section 28.

The priority queue selector 16 selects a predetermined priority queue to which transactions are allocated, according to a probability set in advance based on the priority queues of the priority queue managing section 11. The preset probability is set in advance such that a priority queue of a higher priority is selected more often than a priority queue of a lower priority.

The priority queue selector 16 sequentially selects the telephone system class, the chat system class, and the e-mail system class based on the selected priority queues, and starts the allocation of the transactions queued in each class. In other words, the priority queue selector 16 starts the allocation of the transactions included in the telephone system class. After finishing the allocation of these transactions, the priority queue selector 16 starts the allocation of the transactions included in the chat system class. After finishing the allocation of these transactions, the priority queue selector 16 starts the allocation of the transactions included in the e-mail system class. After the allocation of all the transactions of all the classes is finished, the priority queue selector 16 selects priority queues.

The strict skill matching section 17 matches the required skill level strictly required to process the transaction (refer to FIG. 3B) with the skill level of each operator managed in the operator DB 13, for each transaction of each class of the priority queue selected by the priority queue selector 16.

The strict skill list preparing section 18 extracts operators whose skill levels exceed the required skill level based on the result of the matching by the strict skill matching section 17, and prepares a strict skill list that lists up the extracted operators.

The standby state deciding section 19 decides whether each operator is standby by referring to the processing state managing section 14, for each operator listed up in the strict skill list. Specifically, the standby state deciding section 19 decides whether each operator is standby in the processing of transactions of the system corresponding to the transaction system such as the telephone system, the chat system, or the e-mail system, to which the transaction is to be allocated.

When the relaxed skill list preparing section 25 has prepared a relaxed skill list as described later, the standby state deciding section 19 decides whether each operator is standby by referring to the processing state managing section 14, for each operator listed up in the relaxed skill list.

In deciding the standby state by the standby state deciding section 19, it is possible to change the concept of “standby” according to the type of the skill list. In other words, in deciding the standby state of the operators in the strict skill list, the standby state deciding section 19 may decide that the operators who are standby in their processing of all the types of telephone, chat, and e-mail systems are “standby”. On the other hand, in deciding the standby states of the operators in the relaxed skill list, the standby state deciding section 19 may decide that the operators who are standby in their processing of types of systems to which the transactions are to be allocated are “standby”.

Further, in deciding the standby state by the standby state deciding section 19, it is also possible to change the concept of “standby” according to the type of the transactions to be allocated. In other words, when the type of the transactions to be allocated is the telephone, the standby state deciding section 19 may decide that not only the operators who are standby in their processing of all the types of telephone, chat, and e-mail systems but also the operators who are currently processing only the e-mail transactions are “standby”. In this case, the standby state deciding section 19 decides that the operators who are currently processing the transactions of the telephone or the chat systems are “not standby”.

The standby state list preparing section 20 extracts operators who are standby in their processing based on the result of the decision made by the standby state deciding section 19. The standby state list preparing section 20 further prepares a standby state list by listing up the operators whose standby times are the longest by referring to the processing state managing section 14, for the extracted operators. Specifically, the standby state list preparing section 20 lists up in the standby state list the operators whose “standby state starting time” managed by the processing state managing section 14 is the longest.

The operator selector 21 selects an operator who processes a transaction from among the operators listed up in the standby state list. Specifically, when one operator is listed up in this standby state list, the operator selector 21 selects this operator as the operator who process the transaction. When there are a plurality of operators listed up in this standby state list, the operator selector 21 selects an operator whose skill level exceeds by minimum the required skill level (or the skill level relaxed from this level) to process the transaction as the operator who processes the transaction, by referring to the result of the matching carried out by the strict skill matching section 17 (or the relaxed skill matching section 24 as described later).

When the estimated standby state list preparing section 27 has prepared an estimated standby state list, the operator selector 21 selects an operator who processes a transaction from among the operators listed up in this estimated standby state list. Specifically, in a similar manner to that based on the standby state list, when one operator is listed up in this estimated standby state list, the operator selector 21 selects this operator as the operator who processes the transaction. When there are a plurality of operators listed up in this estimated standby state list, the operator selector 21 selects an operator whose skill level exceeds by minimum the skill level relaxed from the skill level required to process the transaction as the operator who processes the transaction, by referring to the result of the matching carried out by the relaxed skill matching section 24 as described later.

The reason why the operator selector 21 selects the operator whose skill level exceeds by minimum the required skill level (or the skill level relaxed from this level) to process the transaction as the operator who processes the transaction is to take into account the cost of the contact center. In other words, the cost becomes larger when the operator selector 21 selects the operator whose skill level exceeds by a large amount the required skill level (or the skill level relaxed from this level) to process the transaction as the operator who processes the transaction.

The transaction processor 22 sets the transaction to be allocated in the operator queue (in the operator queue managing section 12) of the operators selected by the operator selector 21, and deletes the transaction from the priority queue managing section 11.

When the standby state deciding section 19 has decided that none of the operators are standby by referring to the strict skill list, the permissible waiting time deciding section 23 decides whether the current time exceeds the permissible waiting time, based on the reception time of each transaction to be allocated and the permissible waiting time (refer to Fig and 3B). When the current time does not exceed the permissible waiting time, this transaction allocation processing is postponed (that is, this transaction is to be allocated later again), and the allocation of the next transaction in the priority queue is started.

When the permissible waiting time deciding section 23 has decided that the current time exceeds the permissible waiting time of the transaction to be allocated, the relaxed skill matching section 24 matches the skill level relaxed from the skill level strictly required to process the transaction (refer to FIG. 3B) with the skill level of each operator managed in the operator DB 13.

The relaxed skill list preparing section 25 extracts operators whose skill levels exceed the relaxed skill level based on the result of the matching carried out by the relaxed skill matching section 24, and prepares the relaxed skill list that lists up the extracted operators.

The reason why the relaxed skill list preparing section 25 prepares the relaxed skill list by relaxing the required skill level when the current time exceeds the permissible waiting time of the transaction to be allocated is that the customer satisfaction level is considered higher when the transaction is allocated to the operator who has the relaxed skill level than when a long waiting time that exceeds the permissible waiting time is forced to the customer. Further, this is also because it becomes possible to make even the load of each operator group based on the skill level (refer to FIG. 11).

On the other hand, the reason why the transaction allocation processing is postponed when the current time does not exceed the permissible waiting time is that it is not considered necessary to allocate the transaction to the operator who has the relaxed skill level when the current time does not exceed the permissible waiting time. When the relaxed skill list preparing section 25 has prepared the relaxed skill list, the standby state deciding section 19 decides whether each operator is standby by referring to the processing state managing section 14 for each operator listed up in the relaxed skill list.

When the standby state deciding section 19 has decided that none of the operators are standby by referring to the relaxed skill list, the estimated standby time calculating section 26 subtracts the current time from the sum of the processing starting time and the estimated processing time managed by the processing state managing section 14, and calculates the estimated standby time that shows the estimated time when each operator listed up in the relaxed skill list becomes standby.

The estimated standby state list preparing section 27 extracts operators whose estimated standby times are smaller than the predetermined constant D (refer to FIG. 10) based on the estimated standby time of each operator calculated by the estimated standby time calculating section 26, and prepares the estimated standby state list that lists up the extracted operators. When the estimated standby state list preparing section 27 has prepared the estimated standby state list, the operator selector 21 selects operators who process the transactions from among the operators who are listed up in the estimated standby state list.

The transaction reallocation section 28 monitors the transactions queued in the operator queue managing section 12. When the operator does not start the processing of a transaction within a predetermined time, the transaction reallocation section 28 cancels the allocation of this transaction, and returns the transaction to the priority queue of the priority queue managing section 11 (for example, the original priority queue or a priority queue of which priority is higher than that of the original priority queue). The returned transaction is to be allocated again. The reason why the transaction reallocation section 28 returns the once-allocated transaction is to avoid the occurrence of a customer's long waiting time, by flexibly coping with the situation when the operator's estimated standby time is wrong.

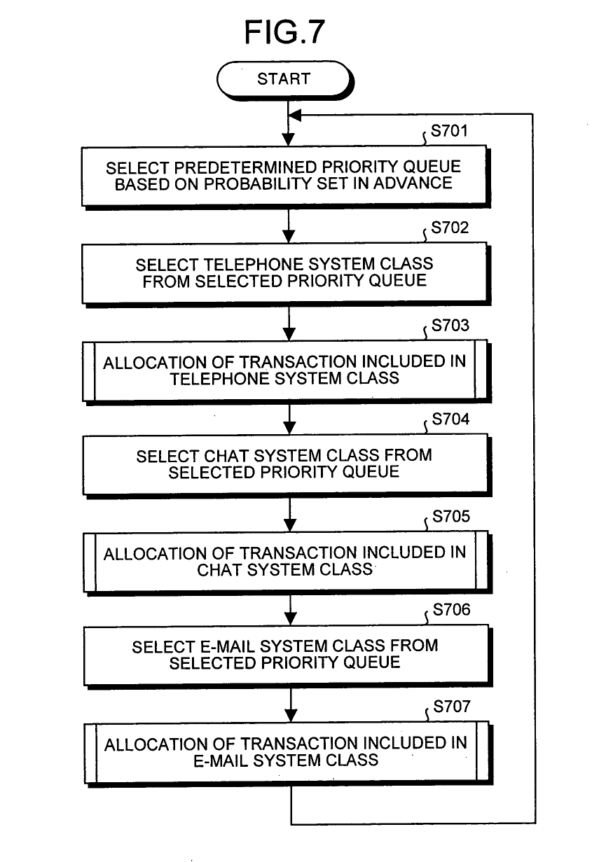

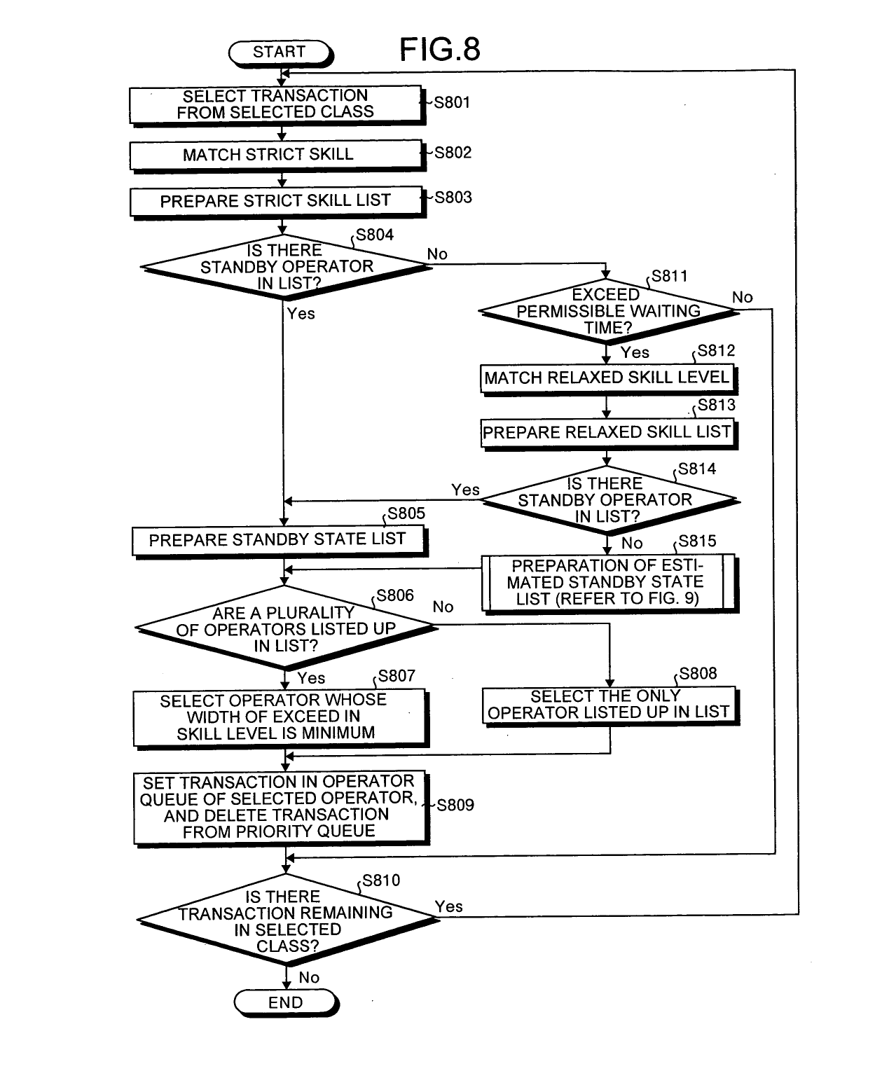

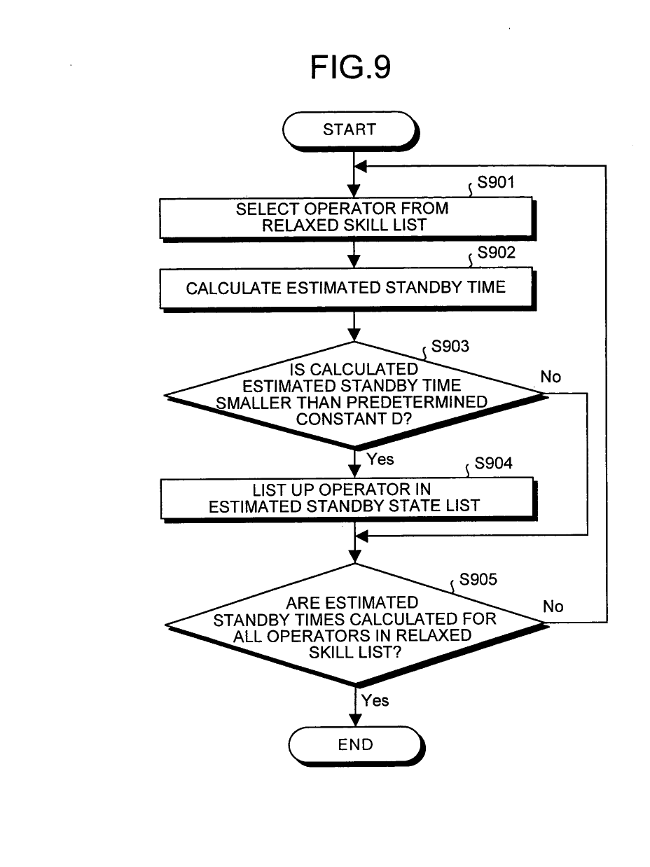

Next, the process in which the transaction allocation apparatus 10 allocates transactions will be explained. FIGS. 7 to 9 are flowcharts that show the process of the transaction allocation processing. More specifically, FIG. 7 shows an outline process of the transaction allocation processing, FIG. 8 shows a detailed process of the transaction allocation processing, and FIG. 9 shows a process of the estiamted standby state list preparation processing. The process of the transaction allocation processing will be explained below with reference to FIGS. 7 to 9.

The outline process of the transaction allocation processing will be explained with reference to FIG. 7. As shown in FIG. 7, in the transaction allocation apparatus 10, the priority queue selector 16 selects a predetermined priority queue to which transactions are allocated, according to a probability set in advance (step S701). Next, the priority queue selector 16 selects the telephone system class from the selected priority queue (step S702), and executes the allocation of each transaction included in this telephone system class (step S703).

When the allocation of each transaction included in the telephone system class has been finished, the priority queue selector 16 selects the chat system class from the selected priority queue (step S704), and executes the allocation of each transaction included in this chat system class (step S705).

When the allocation of each transaction included in the chat system class has been finished, the priority queue selector 16 selects the e-mail system class from the selected priority queue (step S706), and executes the allocation of each transaction included in this e-mail system class (step S707). When the allocation of each transaction included in the e-mail system class has been finished, the priority queue selector 16 selects a priority queue again (step S701).

Through the above series of processing, each transaction queued in each priority queue of the priority queue managing section 11 is sequentially queued in a predetermined operator queue of the operator queue managing section 12.

[Detailed Process of the Transaction Allocation Processing]

A detailed process of the transaction allocation processing, that is, the process of the processing at steps S703, S705, and S707 shown in FIG. 7, will be explained with reference to FIG. 8. As shown in FIG. 8, in the transaction allocation apparatus 10, the priority queue selector 16 selects a transaction from the selected class (step S801). When a transaction of the telephone system class is to be allocated (as shown at step S703 in FIG. 7), the priority queue selector 16 selects a transaction at the head of the telephone system class in the priority queue.

The strict skill matching section 17 matches the required skill level required to process the transaction with the skill level of each operator managed in the operator DB 13, for the transaction selected at step S801 (step S802). Next, the strict skill list preparing section 18 extracts operators whose skill levels exceed the required skill level based on the result of the matching by the strict skill matching section 17, and prepares the strict skill list that lists up the extracted operators (step S803).

Next, the standby state deciding section 19 decides whether each operator is standby by referring to the processing state managing section 14, for each operator listed up in the strict skill list (step S804). The standby state deciding section 19 decides that the operators who are standby in their processing of all the types of telephone, chat, and e-mail systems are “standby”. When the type of the transaction to be allocated is telephone, the standby state deciding section 19 decides that the operators who are currently processing only the e-mail transactions are also “standby”.

When the standby state deciding section 19 has decided that some operators are standby (Yes at step S804), the standby state list preparing section 20 extracts operators who are standby in their processing based on the result of the decision made by the standby state deciding section 19. The standby state list preparing section 20 further prepares the standby state list by listing up the operators whose standby times are the longest by referring to the processing state managing section 14, for the extracted operators (step S805).

The operator selector 21 decides whether there are a plurality of operators listed up in this standby state list (step S806). When only one operator is listed up in this standby state list (No at step S806), the operator selector 21 selects this operator as the operator who processes the transaction (step S808). On the other hand, when there are a plurality of operators listed up in this standby state list (Yes step S806), the operator selector 21 selects an operator whose skill level exceeds the skill level required to process the transaction by minimum as the operator who processes the transaction, by referring to the result of the matching carried out by the strict skill matching section 17 (step S807).

The transaction processor 22 sets the transaction to be allocated in the operator queue (in the operator queue managing section 12) of the operators selected by the operator selector 21, and deletes the transaction from the priority queue managing section 11 (step S809).

The priority queue selector 16 decides whether there are transactions remaining in the selected class (step S810). When there are transactions remaining in the selected class (Yes step S810), the priority queue selector 16 selects the next transaction to be allocated (step S801). On the other hand, when there are no more transactions remaining in the selected class (No step S810), the priority queue selector 16 finishes the allocation processing of this class.

When the standby state deciding section 19 has decided that none of the operators are standby by referring to the strict skill list at step S804 (No at step S804), the permissible waiting time deciding section 23 decides whether the current time exceeds the permissible waiting time, based on the reception time of each transaction to be allocated and the permissible waiting time (step S811). When the permissible waiting time deciding section 23 has decided that the current time does not exceed the permissible waiting time (No at step S811), this transaction allocation processing is postponed. Then, the priority queue selector 16 decides whether there are transactions remaining in the selected class (step S810).

On the other hand, when the permissible waiting time deciding section 23 has decided that the current time exceeds the permissible waiting time (Yes at step S811), the relaxed skill matching section 24 matches the skill level relaxed from the skill level strictly required to process the transaction with the skill level of each operator managed in the operator DB 13 (step S812). The relaxed skill list preparing section 25 extracts operators whose skill levels exceed the relaxed skill level based on the result of the matching carried out by the relaxed skill matching section 24, and prepares the relaxed skill list that lists up the extracted operators (step S813).

Next, the standby state deciding section 19 decides whether each operator is standby by referring to the processing state managing section 14, for each operator listed up in the relaxed skill list (step S814). In other words, the standby state deciding section 19 decides that the operators who are standby in their processing of the system corresponding to the type of the transaction to be allocated are “standby”.

When the standby state deciding section 19 has decided that some operators are standby (Yes at step S814), the standby state list preparing section 20 extracts operators who are standby in their processing based on the result of the decision made by the standby state deciding section 19. The standby state list preparing section 20 further prepares the standby state list by listing up the operators whose standby times are the longest by referring to the processing state managing section 14, for the extracted operators (step S805).

Next, the processing at steps S806 to S810 is carried out. At step S807, unlike the contents of the processing at the above same step, the operator selector 21 selects an operator whose skill level exceeds by minimum the skill level relaxed from the skill level required to process the transaction as the operator who processes the transaction, by referring to the result of the matching carried out by the relaxed skill matching section 24.

At step S814, when the standby state deciding section 19 has decided that none of the operators are standby (No at step S814), the estimated standby time calculating section 26 and the estimated standby state list preparing section 27 prepare the estimated standby state list (step S815).

When the estimated standby state list has been prepared, the processing at steps S806 to S810 is carried out. At step S807, the operator selector 21 selects an operator whose skill level exceeds the skill level required to process the transaction by minimum as the operator who processes the transaction, by referring to the result of the matching carried out by the relaxed skill matching section 24, in a similar manner to that of the above same step.

Through the above series of processing, each transaction of a predetermined class in a predetermined priority queue is sequentially allocated and queued in the operator queue of the operator who processes the transactions.

The process of the estimated standby state list preparation, that is, the process of the processing at step S815 shown in FIG. 8, will be explained with reference to FIG. 9. As shown in FIG. 9, in the transaction processing apparatus 10, the estimated standby time calculating section 26 selects a predetermined operator from the relaxed skill list (for example, the operator at the head in the list) (step S901). The estimated standby time calculating section 26 subtracts the current time from the sum of the processing starting time and the estimated processing time managed by the processing state managing section 14, and calculates the estimated standby time (step S902).

The estimated standby state list preparing section 27 decides whether the estimated standby time is smaller than the predetermined constant D based on the estimated standby time of each operator calculated by the estimated standby time calculating section 26 (step S903). When the estimated standby time is smaller than the predetermined constant D (Yes at step S903), the estimated standby state list preparing section 27 lists this operator in the estimated standby state list (step S904). When the estimated standby time is not smaller than the predetermined constant D (No at step S903), the estimated standby state list preparing section 27 does not list this operator in the estimated standby state list.

The estimated standby state list preparing section 27 decides whether the estimated standby times of all the operators listed up in the relaxed skill list are calculated (step S905). When the estimated standby times of all the operators listed up in the relaxed skill list are calculated (Yes at step S905), the estimated standby state list preparing section 27 finishes the estimated standby state list preparation processing. On the other hand, when the estimated standby times of all the operators are not calculated (No at step S905), the estimated standby time calculating section 26 selects the next operator from the relaxed skill list (step S901), and calculates the estimated standby time of this operator (step S902).

Through the above series of processing, the estimated standby state list that sequentially lists up the operators whose estimated standby times are smaller than the predetermined constant D is prepared, from the operators listed up in the relaxed skill list.

It is possible to realize the transaction allocation apparatus and the transaction allocation method explained in the first embodiment by executing a program prepared in advance with a computer system such as a personal computer and a workstation. In a second embodiment, the computer system for executing a transaction allocation program having similar function to those of the transaction allocation apparatus and the transaction allocation method explained in the first embodiment will be explained.

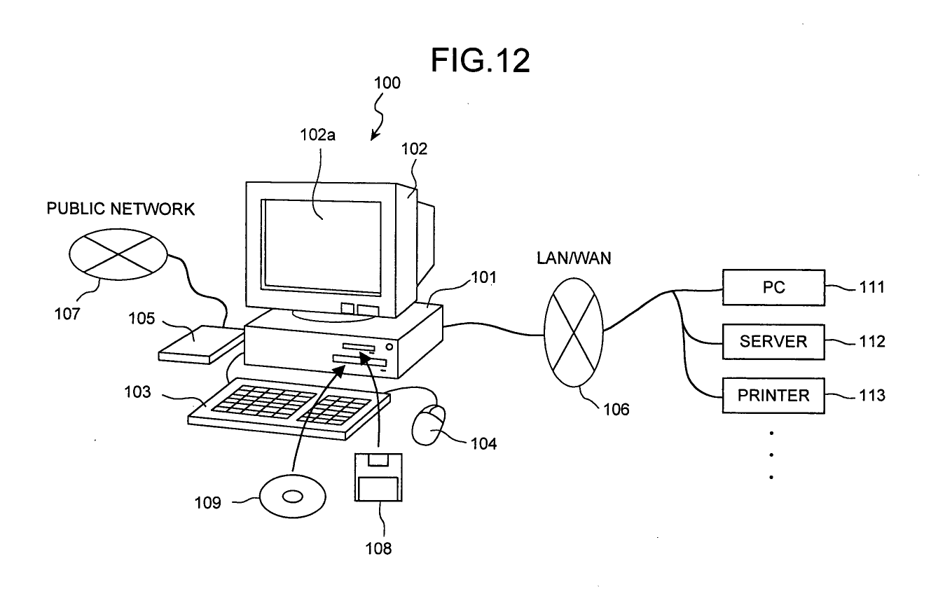

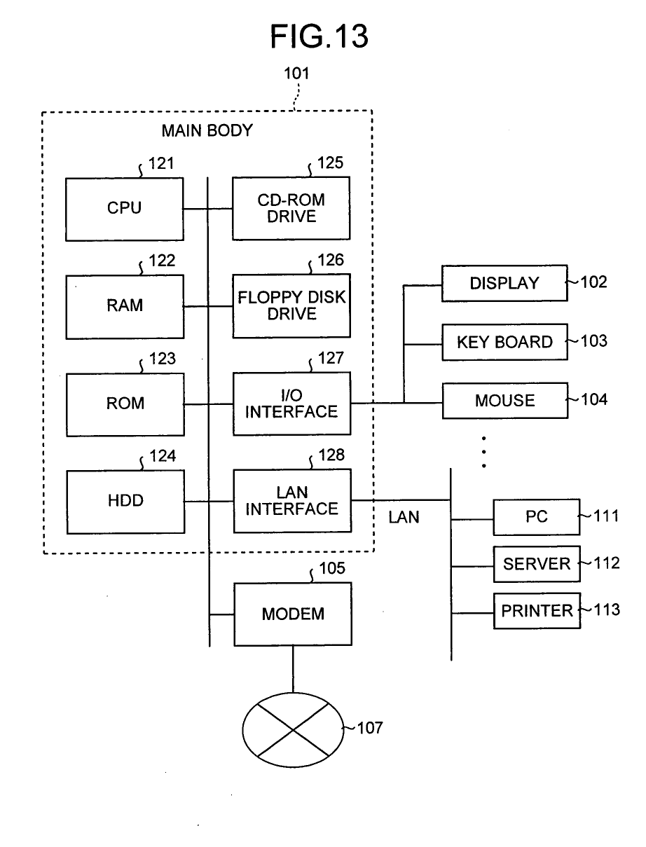

FIG. 12 shows a structure of a computer system according to the second embodiment of the present invention. FIG. 13 is a block diagram that shows a structure of a main body of the computer system. As shown in FIG. 12, a computer system 100 according to the second embodiment has a main body 101, a display 102 that displays information such as an image on a display screen 102a based on an instruction from the main body 101, a keyboard 103 from which various kinds of information are input to the computer system 100, and a mouse 104 used to assign an optional position on the display screen 102a of the display 102.

As shown in FIG. 13, the main body 101 of this computer system 100 has a Central Processing Unit (CPU) 121, a Random Access Memory (RAM) 122, a Read-Only Memory (ROM) 123, a hard disk drive (HDD) 124, a CD-ROM drive 125 that accommodates and drives a CD-ROM 109, an FD drive 126 that accommodates and drives a flexible disk (FD) 108, an I/O interface 127 that connects between the display 102, the keyboard 103, and the mouse 104, and a LAN interface 128 that connects the system to a local area network or a wide area network (LAN/WAN) 106.

The computer system 100 is connected with a modem 105 to connect the system to a public network 107 such as the Internet. Further, the computer system 100 is connected to other computer system (PC) 111, a server 112, and a printer 113, via the LAN interface 128 and the LAN/WAN 106.

The computer system 100 reads the transaction allocation program recorded on a predetermined recording medium and executes this program, thereby to realize the transaction allocation apparatus and the transaction allocation method. The predetermined recording medium includes all kinds of recording mediums for recording the transaction allocation program that can be read by the computer system 100, including a “portable physical medium” such as the flexible disk (FD) 108, the CD-ROM 109, an MO disk, a DVD disk, an optical magnetic disk, and an IC card, a “fixed physical medium” such as the hard disk drive (HDD) 124, the RAM 122, and the ROM 123 provided inside or outside the computer system 100, and a “communication medium” that holds the program for a short period of time to transmit the program such as the public network 107 connected to the system via the modem 105, and the LAN/WAN 106 that connects the system with the other computer system 111 and the server 112.

In other words, the transaction allocation program is recorded on the “portable physical medium”, the “fixed physical medium”, and the “communication medium” so that this program can be read by the computer. The computer system 100 reads the transaction allocation program from these recording mediums, and executes this program, thereby to realize the transaction allocation apparatus and the transaction allocation method. It is also possible to apply the present invention when the other computer system 111 or the server 112 executes the transaction allocation program or when the other computer system 111 and the server 112 operate with each other to execute the transaction allocation program.

While the present invention has been explained based on the above embodiment, it is also possible to apply the present invention in various different embodiments within the range of the technical idea described in the scope of claim for a patent.

In the above embodiment, it is explained that when none of the allocation candidate operators are standby, an operator whose estimated standby time is not more than a predetermined time is selected as the operator who processes a transaction. However, the present invention does not limit the allocation method to this method, and it is also possible that an operator whose estimated standby time is the shortest is selected as the operator who processes a transaction.

In the above embodiment, it is explained that an operator who processes a transaction is selected based on an estimated standby time through the process of matching the skill with the relaxed skill. However, the present invention does not limit the allocation method to this method, and it is also possible that an operator who processes a transaction is selected based on an estimated standby time through only the process of matching the skill with the strict skill without through the process of matching the skill with the relaxed skill.

In the above embodiment, the whole or a part of the processing explained to be carried out automatically can be carried out manually. Further, the whole or a part of the processing explained to be carried out manually can be carried out automatically according to a known method. It is possible to change optionally, except where specified otherwise, the information that includes the processing processes, the control processes, the detailed names, and the various kinds of data and parameters shown in the document and in the drawings.

The constituent elements of the apparatuses shown in the drawings show only the concept of their functions, and it is not always necessary to have physical structures as shown in the drawings. In other words, detailed formats of disintegration and integration of the apparatuses are not limited to those shown in the drawings. It is also possible to structure the whole or a part of the apparatuses by functionally or physically disintegrating or integrating the apparatuses in optional units according to various kinds of loads and using states. Further, it is also possible to realize the whole or an optional part of the processing functions executed by the apparatuses, by the CPU or based on the program that is analyzed and executed by the CPU, or as hardware according to the wired logic control.

As explained above, according to the present invention, when none of the transaction allocation candidate operators are standby in their processing, the operator who processes a transaction is selected based on the estimated standby time, and the transaction is allocated to the selected operator. Therefore, it becomes possible to average the total processing time for each channel taken by the same group operator to process transactions, thereby to make even the load of the same group operator.

Furthermore, the estimated standby time is calculated flexibly according to the variation in the estimated processing time. Therefore, it becomes possible to average the total processing time for each channel taken by the same group operator to process transactions, thereby to make even the load of the same group operator, while taking into account the variation in the estimated processing time taken by each operator.

Moreover, a simple selection method is employed such that an operator whose estimated standby time is the shortest is selected as the operator who processes a transaction. Therefore, it becomes possible to average the total processing time for each channel taken by the same group operator to process transactions, thereby to make even the load of the same group operator.

Furthermore, a transaction is allocated to an operator whose estimated standby time is not more than a predetermined time. Therefore, the total processing time taken by each operator to process transactions becomes substantially the same, regardless of the variation in the estimated processing time taken by each operator. In other words, it becomes possible to average the total processing time taken by each operator to process transactions, thereby to make even the load of each operator.

Moreover, a once-allocated transaction is allocated again. Therefore, it is possible to avoid the occurrence of a customer's long waiting time, by flexibly coping with the situation when the operator's estimated standby time is wrong.

Furthermore, when each operator is a contact center that processes the transactions of each of the three systems of telephone, chat, and e-mail, it becomes possible to average the total processing time taken by each operator to process the transactions of each system, thereby to make even the load of each operator.

Moreover, it becomes possible to average the total processing time taken by each operator to process the transactions, in the group of operators each having the same skill level, thereby to make even the load of each operator.

Furthermore, when a transaction is allocated by relaxing the skill level required to process the transaction, it becomes possible to average the total processing time taken by each operator to process the transactions, in the group of operators each having the same skill level, thereby to make even the load of each operator.

Moreover, an operator whose skill level exceeds the required skill level by a large amount is not selected as the operator who processes the transaction. Therefore, it becomes possible to reduce the cost of the contact center.

Furthermore, an operator whose skill level exceeds by a large amount the skill level relaxed from the required skill level is not selected as the operator who processes the transaction. Therefore, it becomes possible to reduce the cost of the contact center.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A transaction allocation apparatus that selects an operator, from among a plurality of operators, to process a transaction received from a customer and allocates the transaction to the operator selected, the transaction allocation apparatus comprising:
a storing unit that stores status information that is information relating to whether each of the operator is engaged in processing of a transaction or standby at this time;
a standby state deciding unit that decides, based on the status information, which operators are standby at the time the transaction is received from the customer;
a standby time estimating unit that estimates, when the standby state deciding unit has decided that no operator is standby, based on the status information, a standby time for each operator that is a time after which the operator is going to become standby; and
an operator selecting unit that
if the standby state deciding unit has decided that an operator is standby, selects the operator who is standby as the operator to process the transaction, or
if the standby state deciding unit has decided that no operator is standby, selects an operator based on the standby time for each operator as the operator to process the transaction.

2. The transaction allocation apparatus according to claim 1, wherein
the storing unit stores an estimate time for each operator, which is a time taken by the corresponding operator to process the transaction the operator is processing at this time, and also stores a start time, which is a time at which the operator has started the processing of the transaction the operator is processing at this time, and
the standby time estimating unit estimates the standby time based on a current time, the start time, and the estimated time.

3. The transaction allocation apparatus according to claim 1, wherein
if the standby state deciding unit has decided that no operator is standby, the operator selecting unit selects an operator with shortest standby time as the operator to process the transaction.

4. The transaction allocation apparatus according to claim 1, wherein
if the standby state deciding unit has decided that no operator is standby, the operator selecting unit selects an operator from among operators with standby times not more than a predetermined first time as the operator to process the transaction.

5. The transaction allocation apparatus according to claim 1, further comprising:
a canceling unit that cancels allocation of the transaction to the operator selected if the operator selected does not start processing the transaction within a predetermined time, wherein
if allocation of the transaction is canceled by the canceling unit, the standby state deciding unit repeats the decision on which operators are standby.

6. The transaction allocation apparatus according to claim 1, wherein
the transactions are received via any one of telephone, chat, and e-mail,
the storing unit stores the status information separately for the transactions received via the telephone, chat, and e-mail, and
the standby state deciding unit performs the decision on which operators are standby separately for the transactions received via the telephone, chat, and e-mail based on the respective status information.

7. The transaction allocation apparatus according to claim 1, further comprising:
a skill level storing unit that stores a skill level of each operator that is an expertise of the operator in processing transactions; and
an extracting unit that extracts, when the transaction is received, operators whose skill levels exceed the skill levels required to process the transaction based on the skill levels stored, wherein
the standby state deciding performs the decision on which operators are standby from among the operators extracted by the extracting unit.

8. The transaction allocation apparatus according to claim 7, further comprising:
a relaxed candidate extracting unit that relaxes the skill level required to process the transaction, if the standby state deciding unit has decided that no operator is standby, and repeats the extraction of operators, wherein
the standby state deciding unit performs the decision on which operators are standby from among the operators extracted by the relaxed candidate extracting unit.

9. The transaction allocation apparatus according to claim 7, wherein
the operator selecting unit selects an operator whose skill level exceeds the skill level required to process the transaction by minimum as the operator to process the transaction, from among operators with standby times not more than a predetermined third time.

10. The transaction allocation apparatus according to claim 8, wherein
the operator selecting unit selects an operator whose skill level exceeds by minimum the skill level relaxed from the skill level strictly required to process the transaction as the operator to process the transaction, from among operators with standby times not more than a predetermined fourth time.

11. A transaction allocation method of selecting an operator, from among a plurality of operators to process a transaction received from a customer and allocating the transaction to the selected operator, the transaction allocation method comprising:
storing status information that is information relating to whether each of the operator is engaged in processing of a transaction or standby at this time;
deciding, based on the status information, which operators are standby at the time the transaction is received from the customer;
estimating, based on the status information, a standby time for each operator that is a time after which the operator is going to become standby, if it is decided at the deciding that no operator is standby;
selecting
if it is decided at the deciding that an operator is standby, the operator who is standby as the operator to process the transaction, or
if it is decided at the deciding that no operator is standby, an operator based on the standby time for each operator as the operator to process the transaction.

12. The transaction allocation method according to claim 11, wherein
the storing includes storing an estimated time for each operator, which is a time taken by the corresponding operator to process the transaction the operator is processing at this time, and also storing a start time, which is a time at which the operator has started processing of the transaction the operator is processing at this time, and
the estimating estimates the standby time based on a current time, the start time, and the estimated time.

13. The transaction allocation method according to claim 11, wherein
if it is decided at the deciding that no operator is standby, the selecting includes selecting an operator with estimated shortest standby time as the operator to process the transaction.

14. The transaction allocation method according to claim 11, wherein
if it is decided at the deciding that no operator is standby, the selecting includes selecting an operator from among operators with estimated standby times not more than a predetermined time as the operator to process the transaction.

15. The transaction allocation method according to claim 11, further comprising:
canceling the allocation of the transaction to the operator selected, if the operator selected does not start the processing the transaction within a predetermined time, wherein
if allocation of the transaction is canceled at the canceling, the deciding includes repeating the decision on which operators are standby.

16. The transaction allocation method according to claim 11, wherein
the transaction are received via any one of a telephone, chat, and e-mail,
the storing includes storing the status information separately for the transactions received via the telephone, chat, and e-mail, and
the deciding includes performing the decision on which operators are standby separately for the transactions received via the telephone, chat, and e-mail based on the respective status information.

17. The transaction allocation method according to claim 11, further comprising:
the storing includes storing a skill level of each operator that is an expertise of the operator in processing transactions; and
extracting, when the transaction is received, operators whose skill levels exceed the skill levels required to process the transaction based on the skill levels stored, wherein
the deciding includes performing the decision on which operators are standby from among the operators extracted.

18. The transaction allocation method according to claim 17, further comprising:
relaxing the skill level required to process the transaction, if it is decided at the deciding that no operator is standby, wherein
the extracting includes extracting operators whose skill levels exceed the skill levels relaxed, and
the deciding step includes performing the decision on which operators are standby from among the operators extracted after the skill levels were relaxed.

19. The transaction allocation method according to claim 17, wherein
the selecting includes selecting an operator whose skill level exceeds the skill level required to process the transaction by minimum as the operator to process the transaction, from among operators with estimated standby times not more than a predetermined time.

20. The transaction allocation method according to claim 18, wherein
the selecting includes selecting an operator whose skill level exceeds by minimum the skill level relaxed from the skill level strictly required to process the transaction as the operator to process the transaction, from among operators with estimated standby times not more than a predetermined time.

21. A computer program that makes a computer execute a transaction allocation method of selecting an operator, from among a plurality of operators to process a transaction received from a customer and allocating the transaction to the selected operator, the computer program including instruction to realize:
storing status information that is information relating to whether each of the operator is engaged in processing of a transaction or standby at this time;
deciding, based on the status information, which operators are standby at the time the transaction is received from the customer;
estimating, based on the status information, a standby time for each operator that is a time after which the operator is going to become standby, if it is decided at the deciding that no operator is standby;
selecting
if it is decided at the deciding that an operator is standby, the operator who is standby as the operator to process the transaction, or
if it is decided at the deciding that no operator is standby, an operator based on the standby time for each operator as the operator to process the transaction.

22. The computer program according to claim 21, wherein
the storing includes storing estimate time for each operator, which is a time taken by the corresponding operator to process the transaction the operator is processing at this time, and also storing a start time, which is a time at which the operator has started processing of the transaction the operator is processing at this time, and
the estimating estimates the standby time based on a current time, the start time, and the estimated time.

23. The computer program according to claim 21, wherein
if it is decided at the deciding that no operator is standby, the selecting includes selecting an operator with estimated shortest standby time as the operator to process the transaction.

24. The computer program according to claim 21, wherein
if it is decided at the deciding that no operator is standby, the selecting includes selecting an operator from among operators with estimated standby times not more than a predetermined time as the operator to process the transaction.

25. The computer program according to claim 21, further comprising:
canceling the allocation of the transaction to the operator selected, if the operator selected does not start the processing the transaction within a predetermined time, wherein
if allocation of the transaction is canceled at the canceling, the deciding includes repeating the decision on which operators are standby.

26. The computer program according to claim 21, wherein
the transaction are received via any one of a telephone, chat, and e-mail,
the storing includes storing the status information separately for the transactions received via the telephone, chat, and e-mail, and
the deciding includes performing the decision on which operators are standby separately for the transactions received via the telephone, chat, and e-mail based on the respective status information.

27. The computer program according to claim 21, further comprising:
the storing includes storing a skill level of each operator that is an expertise of the operator in processing transactions; and
extracting, when the transaction is received, operators whose skill levels exceed the skill levels required to process the transaction based on the skill levels stored, wherein
the deciding includes performing the decision on which operators are standby from among the operators extracted.

28. The computer program according to claim 27, further comprising:
relaxing the skill level required to process the transaction, if it is decided at the deciding that no operator is standby, wherein
the extracting includes extracting operators whose skill levels exceed the skill levels relaxed, and
the deciding step includes performing the decision on which operators are standby from among the operators extracted after the skill levels were relaxed.

29. The computer program according to claim 27, wherein
the selecting includes selecting an operator whose skill level exceeds the skill level required to process the transaction by minimum as the operator to process the transaction, from among operators with estimated standby times not more than a predetermined time.

30. The computer program according to claim 28, wherein
the selecting includes selecting an operator whose skill level exceeds by minimum the skill level relaxed from the skill level strictly required to process the transaction as the operator to process the transaction, from among operators with estimated standby times not more than a predetermined time.
